(19) United States
(12) Patent Application Publication
(10) Pub. No.: US 2011/0214538 A1
(43) Pub. Date: Sep. 8, 2011

(54) Pair of Pliers with Dual Functions for Snap Ring

(76) Inventor: Hsin-Te Huang, Taichung (TW)

(21) Appl. No.: 12/716,312

(22) Filed: Mar. 3, 2010

(51) Int. Cl. B25B 27/14; B25B 27/20

(52) U.S. Cl. 81/302; 29/229

(57) ABSTRACT

A pair of pliers that is switchable between first and second mode, the pair of pliers comprises a handle assembly including a pair of hand grips pivotally connected to each other and two connected ends respectively extending from the pair of hand grips; a jaw assembly, which is installed onto the connected ends and adapted to couple to a ring, including a plate having a slider rail and two first jaws joined together, with each first jaw having a channel and a pin which is disposed in and slideable along the channel; and a drive member, which is provided between the first jaws and operable between an original position and a moveable position, including a positioning shaft slideably disposed along the slider rail of the plate.

### BACKGROUND OF THE INVENTION

1. Field of the Invention

The present invention relates to a pair of pliers for snap ring, and more particularly to a pair of pliers with dual functions for snap ring by smooth and stable operation.

2. Description of the Related Art

Referring to U.S. Pat. No. 5,826,467, it discloses an easy shift snap ring pliers which is adapted for engaging with different retaining rings, the pliers include a pair of handles pivotally coupled together at a hub having an aperture. A pair of jaws is pivotally coupled together at a shaft which is slideably engaged in the aperture. A positioning member has a lower chamber and an upper chamber for engaging with the shaft and for allowing the shaft to be moved between the upper and lower chambers and for allowing the jaws to engage with different retaining rings. The shaft is slideably positioned in the aperture of the hub and selectively engaged with upper and lower chambers of an M-shaped positioning member. By driving the shaft to slide upward to engage with the upper chamber, the jaws may be moved toward each other when the handles are moved toward each other and such that the jaws may be provided for moving the end portions of a retaining ring toward each other. By driving the shaft to slide downward to engage with the lower chamber, the jaws may be moved away from each other when the handles are moved toward each other and such that the jaws may be provided for moving the end portions of a retaining ring away from each other.

Although the pliers are able to be switched to two different positions by sliding the shaft to selectively engage with the upper and lower chambers. The pliers still has numerous shortcomings. For examples, the M-shaped positioning member is detachably disposed in the aperture of the hub and made by a bent material. Obviously, the structure of the M-shaped positioning member would been worn away during long time use such that the upper and lower chambers which are formed by bending the positioning member might be deformed and the shaft could not be positioned accurately. It causes the pliers can not smoothly switch between two kinds of operating modes. Secondly, the jaws includes an angled channel which consists of upper and lower curved slots and defines an angle, which is approximately 90 degrees, between the upper and lower curved slots. There are pins, which are fixed onto the distal ends of the handle respectively, inserted through the channel and selectively sliding between the upper and lower curved slots. With driving the shaft to slide between the upper and lower chambers, the pins are driven to move between the lower and upper curved slots. However, the angled channel might cause movement of the pins to be not smooth and further result an unsmooth switch of the pliers between the two kinds of operating modes.

Thirdly, the jaws include notches respectively formed in the bottom thereof and adapted for selectively engaging with pins installed onto the handles. Thus, when the shaft is driven to engage with the lower chamber, the notches engage with the pins such the two jaws can be stably abutted against each other before operating the handles. However, to operate the shaft back to engage with the lower chamber from the upper chamber, because each notch is form of a hole with an open end, it has to slightly adjust the relative positions of the two handles to correspond the notches to the pins. The pliers would be switched between the two kinds of operating modes in an inconvenient manner.

The present invention has arisen to mitigate and/or obviate the afore-described shortcomings of the conventional shift snap ring pliers.

### SUMMARY OF THE INVENTION

According to the present invention, it provides a pair of pliers with dual functions for snap ring. The pair of pliers includes a handle assembly, a jaw assembly and a drive member, which can be driven between an original position and a moveable position, and is able to be switched between first and second mode for snap the ring. While in the moveable position of the drive member, first jaws which are coupled to the ring are slideable with respect to the jaw assembly along channels so that the pair of pliers can be switchable between the original and moveable positions.

Other objectives, advantages, and features of the invention will become more apparent from the following detailed description when taken in conjunction with the accompanying drawings.

### BRIEF DESCRIPTION OF THE DRAWINGS

The present invention will be described through detailed illustration of the preferred embodiment referring to the drawings.

FIG. 1 is a perspective view of a pair of pliers with dual functions for snap ring according to the preferred embodiment of the present invention, illustrating the pair of pliers is in the first mode.

FIG. 2 is a partial, exploded perspective view of a pair of pliers according to the preferred embodiment of the present invention.

FIG. 3 is a cross-sectional view of a pair of pliers according to the preferred embodiment of the present invention, illustrating the drive member is in an original position and the flange of the positioning shaft is abutted against the bottom wall of the receptacle.

FIG. 4 is a partial bottom view of the pair of pliers shown in FIG. 1.

FIG. 5a is a partial, top view of pair of pliers shown in FIG. 1, showing the first plate which is fixed onto the handle assembly and the positioning shaft is disposed along the slider rails of the first and second plates while the pair of pliers is in the first mode.

FIG. 5b is a partial, bottom view of pair of pliers shown in FIG. 1, showing the second plate and the positioning shaft is engaged with the second positioned hole of the slider rail while the pair of pliers is in the first mode.

FIG. 6 is a top view of the pair of pliers shown in FIG. 1, illustrating that two clamped ends of a ring are engaged with the two second jaws while the pair of pliers is in the first mode and the hand grips of the handle assembly are not moved toward each other yet.

FIG. 7 is another top view of the pair of pliers similar to FIG. 6, illustrating that the two clamped ends of the ring are moved away from each other while the pair of pliers is in the first mode and the hand grips of the handle assembly are moved toward each other.

FIG. 8a is a partial, top view of the first plate which is fixed onto the handle assembly and the positioning shaft is disposed along the slider rails of the first and second plates similar to FIG. 5a, but illustrating that the pair of pliers is going to be driven to the second mode from the first mode.

FIG. 8b is a partial, bottom view of pair of pliers shown in FIG. 1, showing the second plate and the positioning shaft is engaged with the second positioned hole of the slider rail while the pair of pliers is going to be driven to the second mode from the first mode.

FIG. 9a is a partial, top view of the first plate which is fixed onto the handle assembly and the positioning shaft is disposed along the slider rails of the first and second plates similar to FIG. 5a, but illustrating that the pair of pliers is in the second mode.

FIG. 9b is a partial, bottom view of pair of pliers shown in FIG. 1, showing the second plate and the positioning shaft is engaged with the second positioned hole of the slider rail while the pair of pliers is in the second mode.

FIG. 10 is another cross-sectional view of the pair of pliers similar to FIG. 3, but illustrating that the drive member is switched to the moveable position while pressing the pressed end of the positioning shaft toward the engaged element.

FIG. 11 is a perspective view of a pair of pliers with dual functions for snap ring according to the preferred embodiment of the present invention, illustrating the pair of pliers is in the second mode.

FIG. 12 is a partial, enlarged top view of the pair of pliers shown in FIG. 11.

FIG. 13 is a top view of the pair of pliers shown in FIG. 11, illustrating that two clamped ends of the ring are engaged with the two second jaws while the pair of pliers is in the second mode and the hand grips of the handle assembly are not moved toward each other yet.

FIG. 14 is another top view of the pair of pliers similar to FIG. 13, but illustrating that the two clamped ends of the ring are moved toward each other while the pair of pliers is in the second mode and the hand grips of the handle assembly are moved toward each other.

### DETAILED DESCRIPTION OF THE PREFERRED EMBODIMENT

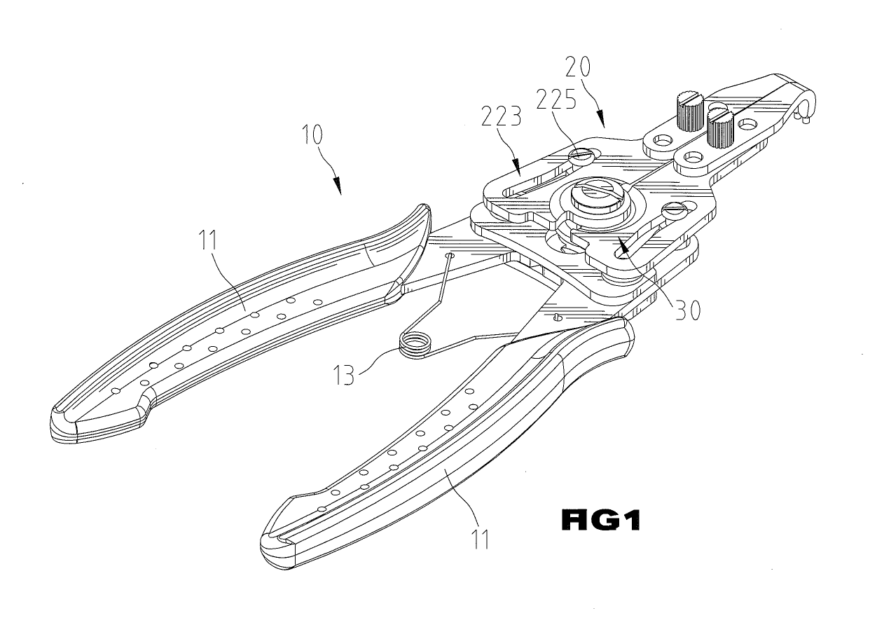

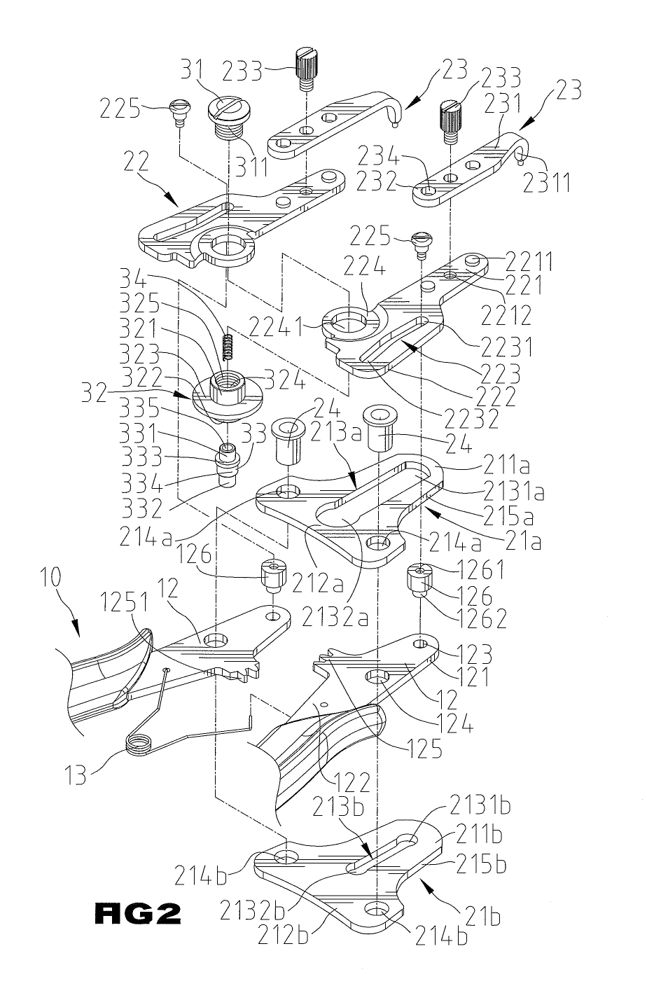

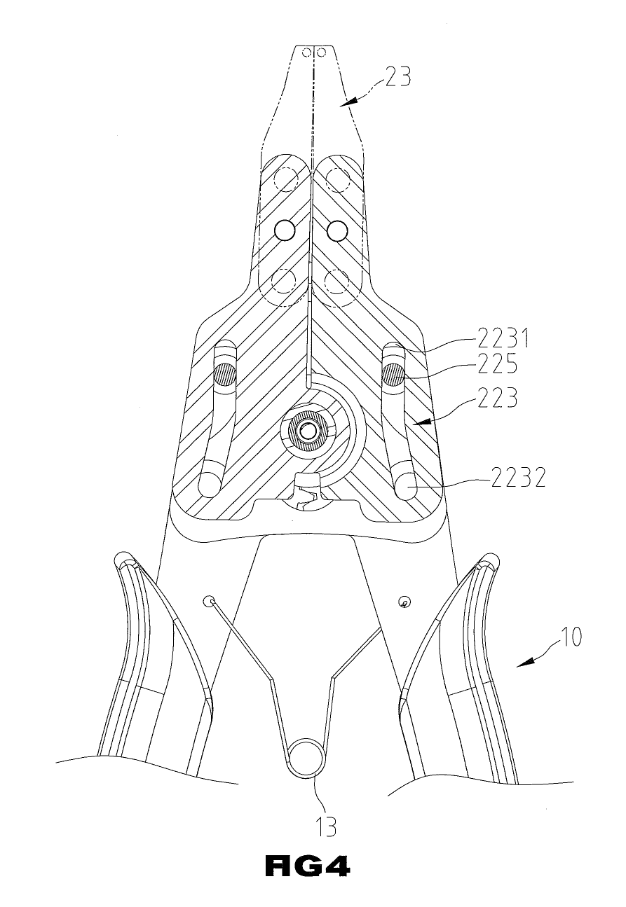

For a better understanding of the preferred embodiment of the present invention, reference is made to FIGS. 1 to 14. A pair of pliers with dual functions for snap ring includes a handle assembly 10, a jaws assembly 20 and a drive member 30. The handle assembly 10 includes a pair of hand grips 11 and each hand grip 11 has a connected end 12. Each connected end 12, which has a first end 121 defined at the distal end of the related hand grip 11 and a second ends 122 coupled to the related hand grip 11, includes a first fixed hole 123 formed at the first end 121 of the connected end 12, a second fixed hole 124 formed between the first and second ends 121, 122 and a wedged portion 125 provided at a side thereof. The wedged portions 125 of the two connected ends 12 face and engage with each other pivotally via teeth 1251. A resilient member 13 which has two legs (not numbers) hooking to the second ends 122 of the connected ends 12 respectively is adapted to pivotally connect the two connected ends 12 to each other. Two connectors 126 are respectively installed onto the first fixed holes 123 and each connector 126 has an engaged hole 1261 and a fixed end 1262 formed on two ends thereof. The fixed end 1262 is adapted for inserting into the related first fixed hole 123 and the engaged hole 1261 is toward the jaw assembly 20.

The jaws assembly 20 is installed to the connected ends 12 and includes a first plate 21a, a second plate 21b, two first jaws 22 and two second jaws 23. The first and second plates 21a, 21b are respectively provided above and below the connected ends 12; in this case, the profiles of the first and second plates 21a, 21b are similar to each other except several features which would be discussed in detail below. The two symmetrical first jaws 22 which are joined together are disposed onto the first plate 21a. The two second jaws 23 are respectively coupled onto the first jaws 22.

The first plate 21a forms with a first end 211a and a second end 212a having a larger width than that of the first end 211a. A slider rail 213a is aligned with a longitudinal centerline of first plate 21a and extends from the first end 211a to the second ends 212a. First and second positioned holes 2131a and 2132a are respectively formed on two ends of the slider rail 213a and adjacent to the first and second ends 211a and 212a. A diameter of the first positioned hole 2131a is smaller than that of the second positioned hole 2132a. Two secured holes 214a are defined on the second ends 212a and on two sides of the second positioned hole 2132a.

The second plate 21b is substantially similar to the first plate 21a and includes first and second ends 211b and 212b, a slider rail 213b and two secured holes 214b except that the slider rail 213b is smaller than the slider rail 213a and a diameter of the first positioned hole 2131b is equal to that of the second positioned hole 2132b. The length and the width of the slider rail 213a are both larger than that of the slider rail 213b. The secured holes 214a correspond to the secured holes 214b, and two fasteners 24 are inserted through the secured holes 214a, the second fixed holes 124 of the handle assembly 10 and the secured holes 214b for securing the first and second plates 21a, 21b to the handle assembly 10.

Two curved sides 215a are respectively formed on two sides of the first plate 21a and two curved sides 215b are respectively formed on two sides of the second plate 21b so that the first fixed holes 123 are exposed from the first and second plates 21a, 21b.

Each first jaw 22, which has a first end 221 and a second end 222 extending from the first end 221 and having a larger width than the first end 221, includes a channel 223 formed longitudinally on a side of the second end 222 and a circular portion 224 formed on another side of the second end 222 and joined to another circular portion 224. Each circular portion 224 has a through-hole 2241 and corresponds to the slider rails 213a, 213b. Each channel 223 is not straight and has first section 2231 and second section 2232. The first and second sections 2231, 2232 form an obtuse angle. A first pins 225 is provided to insert through each channel 223 and engaged with the engaged hole 1261 of the related connector 126. The first jaws 22 are able to slide with respect to the handle assembly 10 via the first pins 225 and the channels 223 between the first and second sections 2231, 2232. And because of the obtuse angle formed by the first and second sections 2231, 2232, the first jaws 22 can smoothly slide with respect to the handle assembly 10 and it prevents that the first pin 225 slides along the related channel 223 through a connection of the first and second sections 2231, 2232 unsmoothly. The drive member 30 is provided to insert through the through-holes 2241 and the slider rails 213a, 213b and able to slide along the slider rails 213a, 213b and in the meanwhile, the first pins 225 would be driven to slide along the channels 223. The structure of the drive member 30 will be discussed in detail below.

Each second jaw 23 is disposed on and installed to the first end 221 of the related first jaw 22. First end 231 and second end 232 are respectively defined at two ends of each second jaw 23 and the first end 231 extends over the related first jaw 22 and is bent to form an angle which is approximate 90 degrees. However, the angle that is formed by the first end 231 of the second jaw 23 can be zero or less than 90 degrees to meet user's needs. A tip (not numbered) is formed on the distal end of the first end 231 of each second jaw 23 and adapted to engage with an orifice 411 of each of two clamped ends 41 of a ring 40. Numbers of holes 234 are formed on the second end 232 and a second pin 233 is inserted through one of the holes 234 and engaged with an aperture 2212 which is defined on the first end 221 of each first jaw 22 in a screw manner as to couple the second jaws 23 to the first jaws 22. Several bosses 2211 protrude on the first end 221 of each first jaw 22 and join with the other holes 234 as to firmly secure the second jaws 23 onto the first jaws 22.

The drive member 30 includes an engaged element 31, a linkage 32, a positioning shaft 33 and an elastic element 34. The engaged element 31 has a threaded portion 311 formed on an end thereof and engaged with the linkage 32 and a space 312 defined inside of the threaded portion 311 and opened toward the linkage 32. The linkage 32 includes an engaged end 321 and a receiving end 322 formed on two ends thereof respectively. A disc portion 323 is defined between the engaged end 321 and the receiving end 322. A receptacle 324 is defined in the linkage 32 from the engaged end 321 to the receiving end 322 and a threaded periphery 325 is defined on the inner wall of the receptacle 324 at the engaged end 321. An opening 327 is provided at the receiving end 322 and opened opposite to the engaged end 321. A diameter of the opening 327 is slightly smaller than the receptacle 324. Thus, a bottom wall 326 is defined inside of the receiving end 322 and abutted against the opening 327. The positioning shaft 33 includes a storing end 331 and a pressed end 332 respectively defined at two ends thereof. A flange 333 and a positioning portion 334 are provided between the storing and pressed ends 331, 332. A receiving hole 335 is defined in the storing end 331 toward the linkage 32. The outer diameter of the storing end 331 is equal to the inner diameter of the space 312. The outer diameter of the flange 333 is equal to the receptacle 324 but larger than the diameter of the opening 327 which is equal to the outer diameter of the positioning portion 334.

To assemble the drive member 30 and install the drive member 30 to the jaw assembly 20, firstly, the threaded portion 311 of the engaged element 31 is engaged with the threaded periphery 325 of the linkage 32 and then, the engaged element 31 is partially exposed from the engaged end 321 of the linkage 32; secondly the receiving end 322 of the linkage 32 is coupled to the storing end 331 and the flange 333 is selectively abutted with the bottom wall 326 of the linkage 32 via the elastic element 34 which is disposed in the receiving hole 335 and has two ends respectively abutted against the inner wall of the engaged element 31 and the positioning shaft 33. The positioning portion 334 is able to be driven to insert into the receptacle 324 completely or not by pressing the pressed end 332 toward the linkage 32. With the positioning portion 334 being inserted into the receptacle 324, the storing end 331 is driven to insert in the space 312 and the elastic element 34 is pressed. The outer diameter of the engaged end 321 is equal to that of the receiving end 322 but smaller than that of the disc portion 323; hence, the engaged end 321 of the linkage 32 is inserted through the first jaws 22 and the disc portion 323 of the linkage 32 is provided between the first jaws 22 and the first plate 21a for fixing the drive assembly 30 in the jaw assembly 20. The receiving end 322 of the linkage 32 is inserted in the slider rail 213a of the first plate 21a.

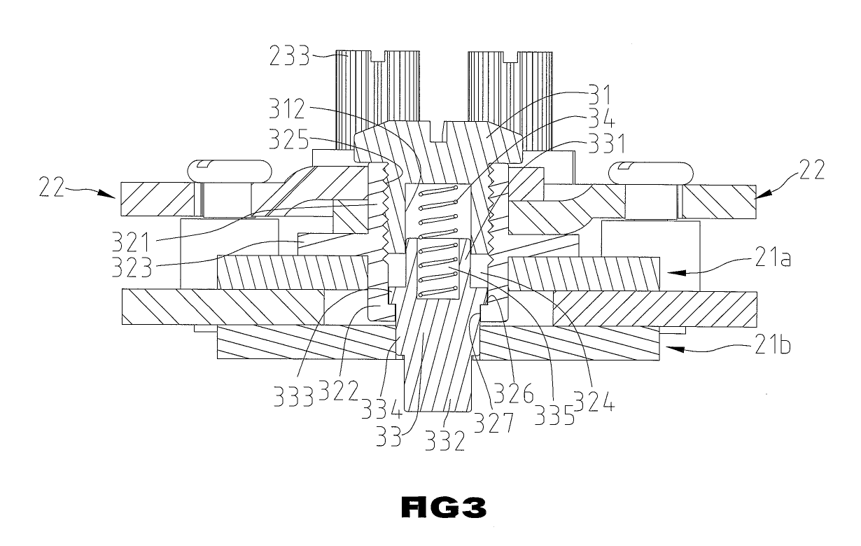

The drive member 30 is able to be switched between an original position and a moveable position. While in the original position of the drive member 30, as shown in FIG. 3, the elastic element 34 is released and the positioning shaft 33 is pressed toward the second plate 21b so that the flange 333 is abutted against the bottom wall 326 and the positioning portion 334 is positioned in the slider rail 213b partially. In this case, the outer diameter of the positioning portion 334 is smaller than that of the flange 333 but larger than that of the pressed end 332; however, the diameter of the second positioned hole 2132b is equal to the outer diameter of the positioning portion 334 but larger than the pressed end 332. Therefore, the drive member 30 can not move with respect to the jaw assembly 20 while in the original position. Moreover, the larger second positioned hole 2132a is adapted for installing the receiving end 322 of the linkage 32 and the positioning shaft 33 to the jaw assembly 20; in the meanwhile, the disc portion 323 is disposed onto the first plate 21a.

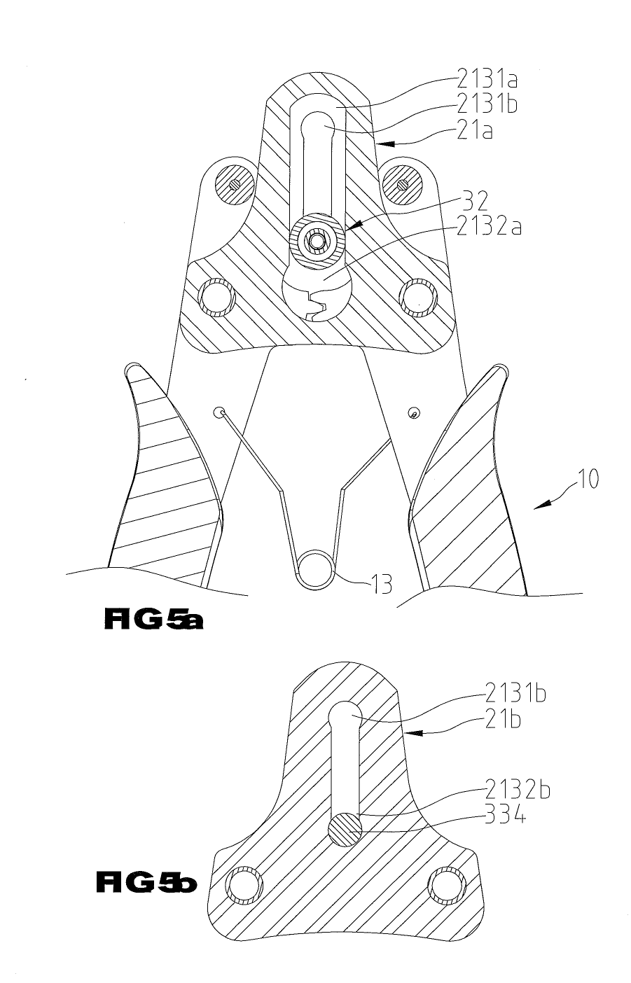

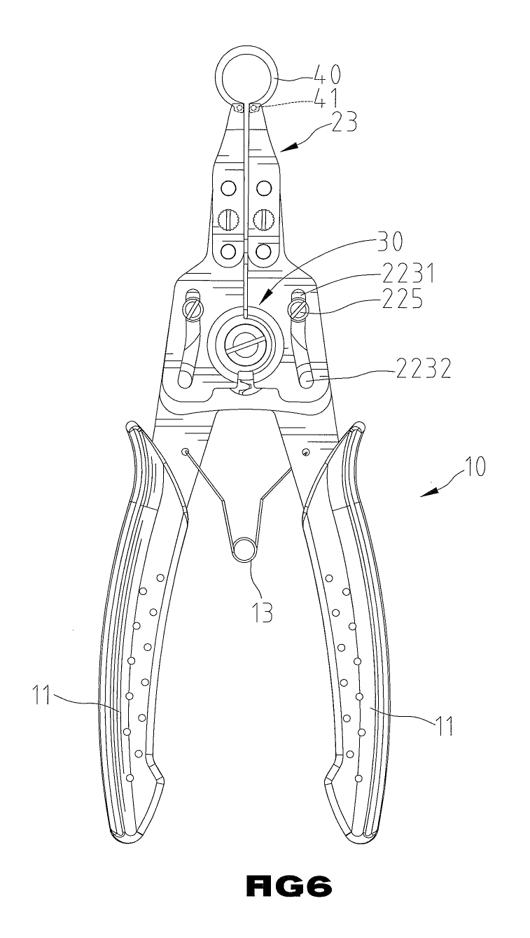

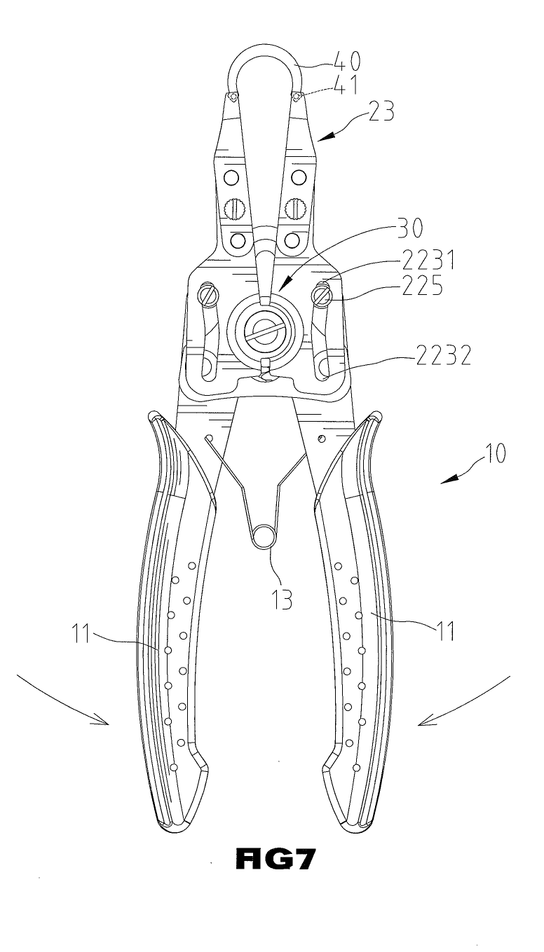

Referring to FIGS. 5a and 5b, they show that the pair of pliers is in the first mode and the drive member 30 is in the original position. The positioning portion 334 is engaged with the second positioned hole 2132b. Further referring to FIGS. 6 and 7, the first pins 225 are respectively disposed in the first sections 2231 of the channels 223. In the first mode of the pair of pliers and in the original position of the drive member 30, the first jaws 22 are closed to each other and the second jaws 23 are not moved away from each other yet.

In FIG. 6, the two clamped ends 41 of the ring 40 are closed to each other and the two first jaws 22 are not moved away from each other yet. In FIG. 7, the hand grips 11 are driven to move toward each other along arrow directions as shown in the drawings, and then, the two first jaws 22 are driven to move away from each other so that the clamped ends 41 are forced to move away from each other and the ring 40 is deformed.

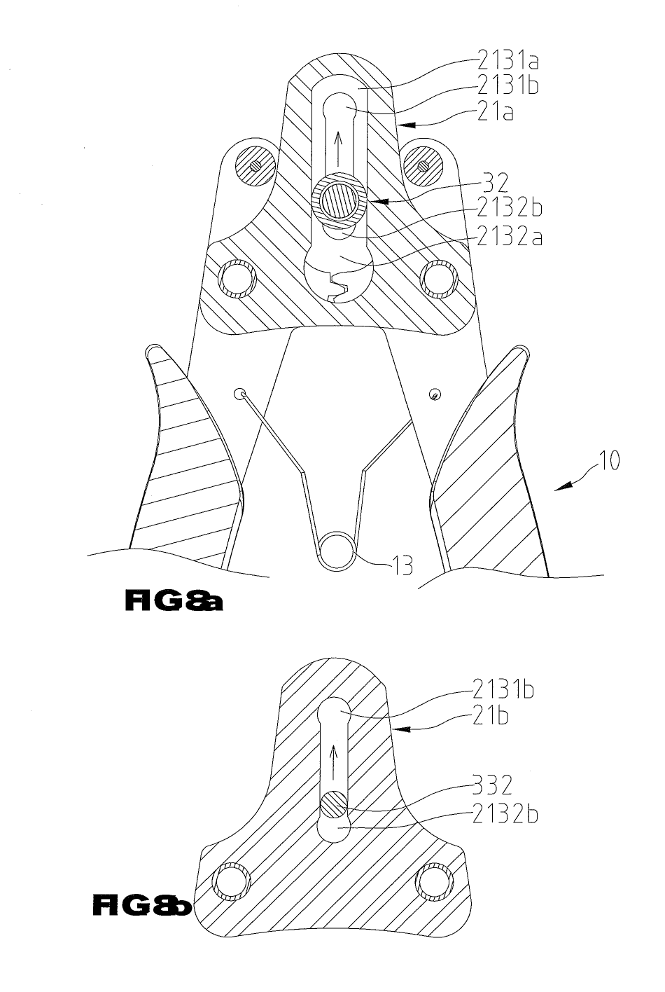

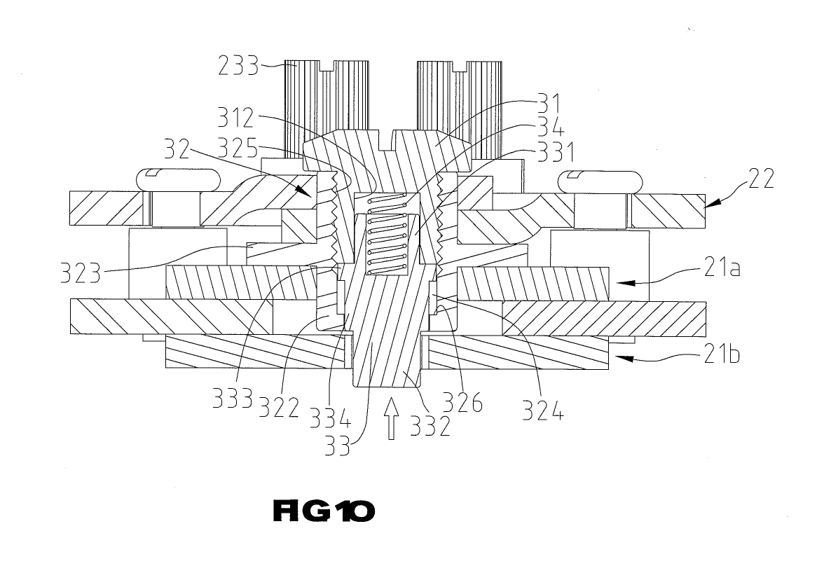

Referring to FIGS. 8a and 8b, they show that the pair of pliers is switched to the second mode from the first mode. Further referring to FIG. 10, in order to switch the pair of pliers to the second mode, the pressed end 332 has to be pressed toward the engaged element 31 along the arrow direction shown in the drawing. And then, the elastic element 34 is compressed and the positioning portion 334 is disengaged from the slider rail 213b so that the positioning shaft 33 of the drive member 30 can slide along the slider rail 213b with respect to the first pins 225 which slide along the channels 223.

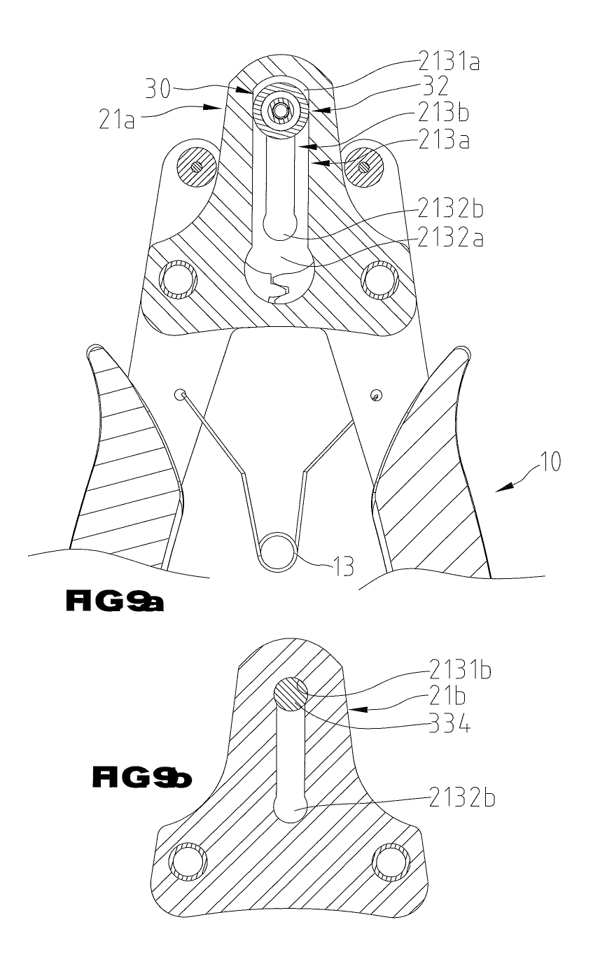

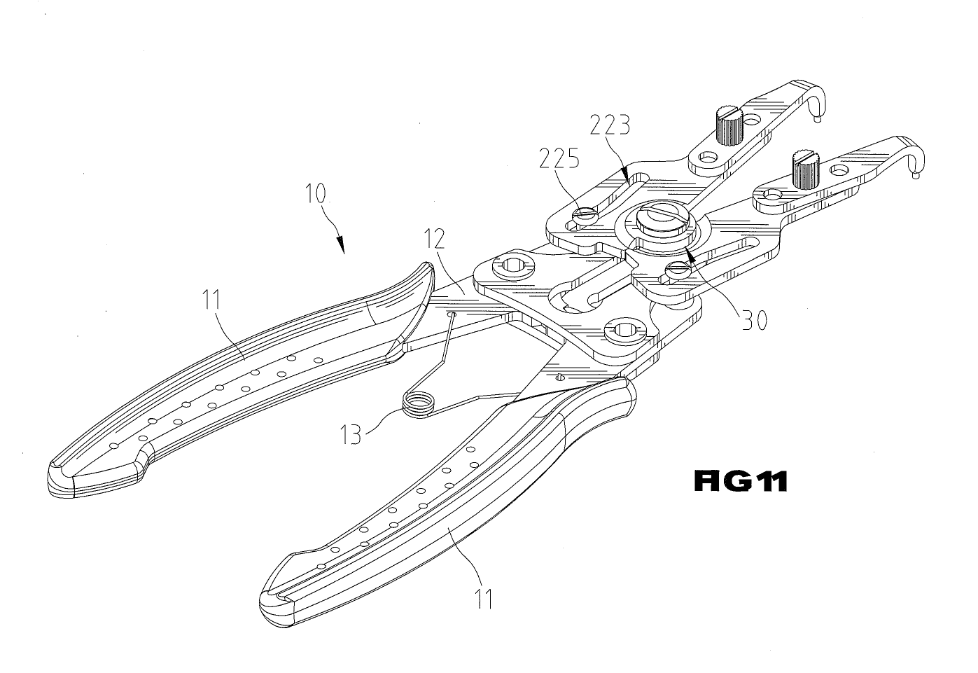

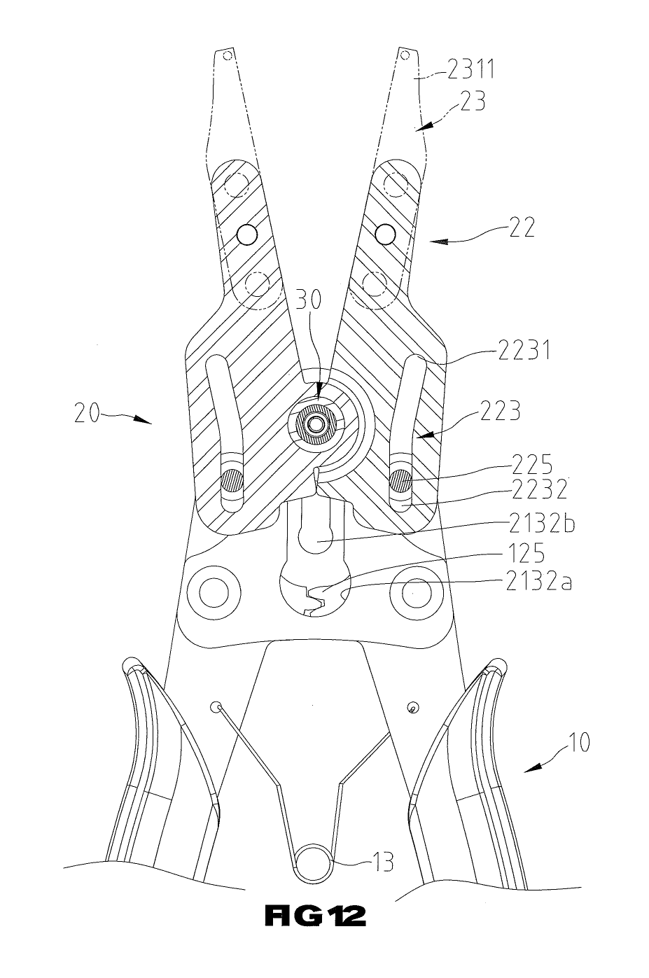

Referring to FIGS. 9a and 9b, they show that the pair of pliers is in the second mode and the positioning shaft 33 is engaged with the first positioning hole 2131b of the slider rail 213b. Further referring to FIGS. 11 and 12, in the second mode of the pair of pliers, the first pins 225 are disposed in the second sections 2232 of the channels 223. The first jaws 22 are not moved toward each other with the second jaws 23 before operating.

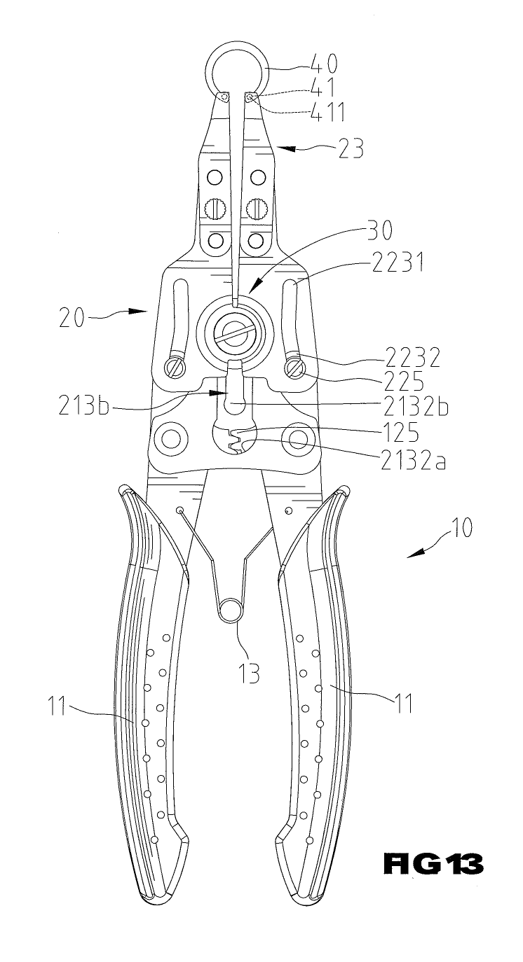

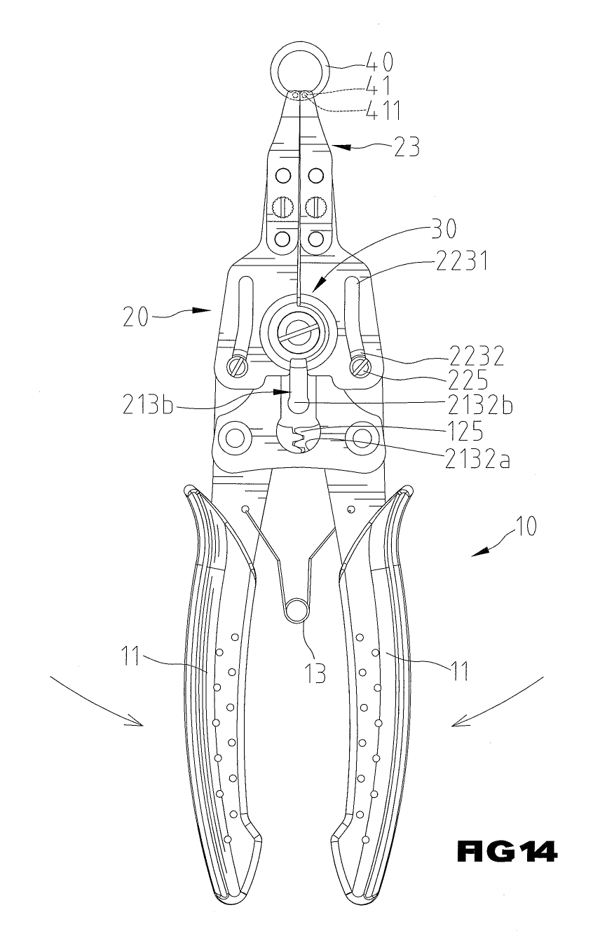

Referring to FIGS. 13 and 14, the first pins 225 are respectively disposed in the second sections 2232 of the channels 223. In the second mode of the pair of pliers and in the original position of the drive member 30, the first jaws 22 are away from each other and the second jaws 23 are not moved toward each other yet.

In FIG. 13, the two clamped ends 41 of the ring 40 are away from each other and the two first jaws 22 are not moved toward each other yet. In FIG. 14, the hand grips 11 are driven to move toward each other along arrow directions as shown in the drawings, and then, the two first jaws 22 are driven to move toward each other so that the clamped ends 41 are forced to move toward each other and the ring 40 is deformed to be closed.

In this present invention, the pair of pliers can be smoothly operated between the first and second modes via the drive member. While the drive member is driven to the moveable position by pressing the pressed end of the positioning shaft, the drive member can drive the first and second jaws of the jaw assembly to slide along the channels via the first pins. In the first mode of the pair of pliers, the first jaws are closed to each other before operating the handle assembly for forcing the two clamped ends of the ring to be away from each other. In the second mode of the pair of pliers, the first jaws are away from each other before operating the handle assembly for forcing the two clamped ends of the ring to move toward each other and closing the ring.

While several embodiments of the invention have been shown and described, it will be apparent to those skilled in the art that modifications may be made therein without departing from the scope and spirit of the present invention.

What is claimed is:

1. A pair of pliers that is switchable between first and second mode, the pair of pliers comprising:
a handle assembly including a pair of hand grips pivotally connected to each other and two connected ends respectively extending from the pair of hand grips;
a jaw assembly, which is installed onto the connected ends and adapted to couple to a ring, including a plate having a slider rail and two first jaws joined together, with each first jaw having a channel and a pin which is disposed in and slideable along the channel; and
a drive member, which is provided between the first jaws and operable between an original position and a moveable position, including a positioning shaft slideably disposed along the slider rail of the plate;
wherein in the original position of the drive member, the positioning shaft can not slide along the slider rail of the jaw assembly and the first jaws cannot move with respect to the plate via cooperation of the pins and the channels;
wherein in the moveable position of the drive member, the positioning shaft is slideable along the slider rail of the jaw assembly and the first jaws are driven to slide with respect to the plate and the first pins slide along the channels respectively so that the pair of pliers can selectively be the first or second modes;
wherein while the pair of pliers is in the first mode, the first jaws are closed to each other before operating the hand grips to move toward each other so that user drives the hand grips to move toward each other for pushing a closed ring open; wherein while the pair of pliers is in second mode, the first jaws are away from each other before operating the hand grips to move toward each other so that user drives the hand grip to move toward each other forcing two clamped ends of the ring to move toward each other and closing the ring.

2. The pair of pliers as claimed in claim 1, wherein each channel has first section and second section, with the first pins being slideable between the first and second sections of the channels; wherein while the first pins is disposed in the first sections, the pair of pliers is in the first mode; wherein while the first pins is disposed in the second sections, the pair of pliers is in the second mode.

3. The pair of pliers as claimed in claim 2 wherein the slider rail of the plate has first and second positioning holes, with while the positioning shaft of the drive member is engaged with the second positioning hole, the pair of pliers is in the first mode, and with while the positioning shaft of the drive member is engaged with the first positioning hole, the pair of pliers is in the second mode.

4. The pair of pliers as claimed in claim 1, wherein the jaw assembly includes first and second plates, with the connected ends sandwiched by the first and second plates; further including slider rails respectively formed on the first and second plates, with the drive member slideably disposed between the slider rails

5. The pair of pliers as claimed in claim 1, further comprising two second jaws respectively installed onto the first jaws and adapted to couple to the two clamped ends of the ring for snap the ring.

6. The pair of pliers as claimed in claim 1 wherein the drive member further includes an engaged element, a linkage and an elastic element, with the linkage interconnecting the engaged element and the positioning shaft, with the elastic element disposed in the linkage between the engaged element and the positioning shaft for controlling the drive member to between the original and moveable positions.

7. The pair of pliers as claimed in claim 6, with the engaged element having a threaded portion formed on an end thereof and engaged with the linkage and a space defined inside of the threaded portion and opened toward the linkage, with the linkage including an engaged end and a receiving end formed on two ends thereof respectively, with a disc portion defined between the engaged end and the receiving end, with a receptacle defined in the linkage from the engaged end to the receiving end, and with an opening provided at the receiving end and opened opposite to the engaged end, with a diameter of the opening is slightly smaller than the receptacle.

8. The pair of pliers as claimed in claim 7, wherein the positioning shaft includes a storing end and a pressed end respectively defined at two ends thereof, with a flange and a positioning portion provided between the storing and pressed ends, with a receiving hole defined in the storing end toward the linkage, with the outer diameter of the storing end being equal to the inner diameter of the space, with the outer diameter of the flange being equal to the receptacle but larger than the diameter of the opening which is equal to the outer diameter of the positioning portion.

9. The pair of pliers as claimed in claim 1 further comprising a circular portion formed on a side of each first jaw opposite to the channel, with the two circular portions joined to each other for pivotally connecting the first jaws to each other, with each circular portion having a through-hole and corresponding to the slider rail of the plate.

10. The pair of pliers as claimed in claim 4 further comprising a circular portion formed on a side of each first jaw opposite to the channel, with the two circular portions joined to each other for pivotally connecting the first jaws to each other, with each circular portion having a through-hole and corresponding to the slider rails of the first and second plates.

11. The pair of pliers as claimed in claim 1 further comprising two connectors respectively installed onto the connected ends, with the pin provided to insert through each channel and engaged with the related connector so that the first jaws are able to slide with respect to the handle assembly via the first pins and the channels between the first and second sections.

12. The pair of pliers as claimed in claim 4 further comprising first and second positioned holes are respectively formed on two ends of the slider rail of the first plate, with a diameter of the first positioned hole of the first plate smaller than that of the second positioned hole of the first plate; wherein the slider rail of the second plate includes first and second positioned holes respectively formed on two ends thereof, with a diameter of the first positioned hole of the second plate equal to that of the second positioned hole of the second plate but smaller than that of the second positioned hole of the first plate.

13. The pair of pliers as claimed in claim 12, further comprising two curved sides respectively formed on two sides of the first plate and two curved sides are respectively formed on two sides of the second plate.

14. The pair of pliers as claimed in claim 9 wherein the channel is formed longitudinally on the second end of the related first jaw opposite to the circular portion.

15. The pair of pliers as claimed in claim 10 wherein the channel is formed longitudinally on the second end of the related first jaw opposite to the circular portion.

16. The pair of pliers as claimed in claim 14, with each channel not being straight, with the first and second sections forming an obtuse angle.

17. The pair of pliers as claimed in claim 15, with each channel not being straight, with the first and second sections forming an obtuse angle.
